(19) United States
(12) Patent Application Publication
(10) Pub. No.: US 2012/0010544 A1
(43) Pub. Date: Jan. 12, 2012

(54) KNEADING MASSAGE DEVICE

(75) Inventor: Jui-Yao Chen, Yongjing Township (TW)

(73) Assignee: ST LIFE CO., LTD., DALI CITY (TW)

(21) Appl. No.: 12/831,317

(22) Filed: Jul. 7, 2010

(51) Int. Cl. A61H 7/00

(52) U.S. Cl. 601/134

(57) ABSTRACT

A kneading massage device includes a driving motor having a first transmission shaft and a second transmission shaft; a first gear engaged with the first transmission shaft and provided with a first transmission shank; a first rotary seat coupled with the first transmission shank, a first massage unit being disposed on the first rotary seat; a second gear engaged with the second transmission shaft and provided with a second transmission shank; and a second rotary seat coupled with the second transmission shank. A second massage unit is disposed on the second rotary seat. When the driving motor drives the first and second transmission shafts to rotate, the first and second massage units are synchronously driven and rotated.

### FIELD OF THE TECHNOLOGY

The present invention relates generally to a massage device, and more particularly to a kneading massage device with kneading function.

### BACKGROUND

In modern life, people get busier and busier in working and studying. People take little time for rest and leisure, especially those white-collar workers who sit in front of computers all day long. These white-collar workers always suffer from radiation of the computers and fatigue of hands, necks, cervical spines, feet and waists. In some more serious cases, some workers may have cervical spondylosis and frozen shoulders. Various massage devices directed to these problems are now available in the market. The existent handheld massage devices can be generally divided into percussion type, vibration type and rolling type. All these massage devices fail to provide kneading effect as required by consumers.

Various versatile massage chairs are also now available in the market. Such massage chairs have kneading, percussion, vibration and rolling massage functions. However, these massage chairs are quite expensive and will occupy much room. Moreover, such massage chairs cannot be readily used as desired.

### SUMMARY

A primary object of the present invention is to provide a kneading massage device capable of providing kneading effect.

According to the above and other objects, the kneading massage device of the present invention includes: a driving motor having a first transmission shaft and a second transmission shaft; a first gear engaged with the first transmission shaft and provided with a first transmission shank; a first rotary seat coupled with the first transmission shank, a first massage unit being disposed on the first rotary seat; a second gear engaged with the second transmission shaft and provided with a second transmission shank; and a second rotary seat coupled with the second transmission shank. A second massage unit is disposed on the second rotary seat. When the driving motor drives the first and second transmission shafts to rotate, the first and second massage units are synchronously driven and rotated.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a part of the present invention;

FIG. 2 is a perspective exploded view of the present invention; and

FIG. 3 is a perspective assembled view of the present invention.

### DETAILED DESCRIPTION

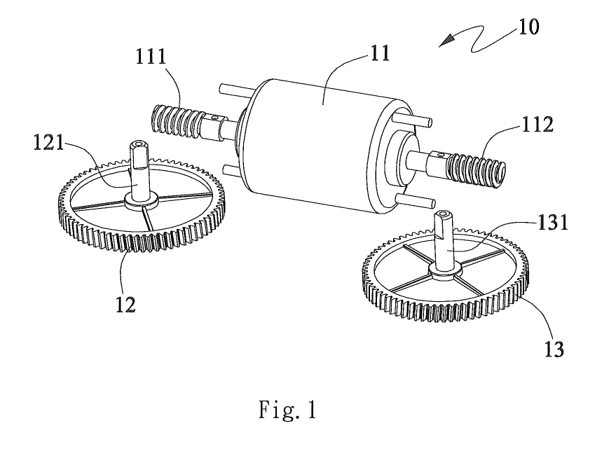

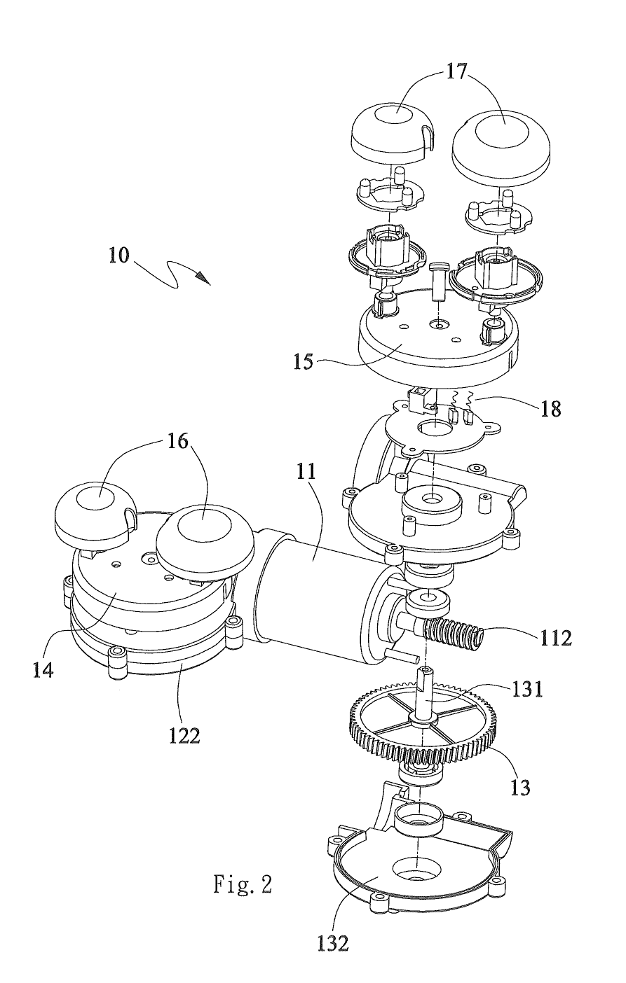

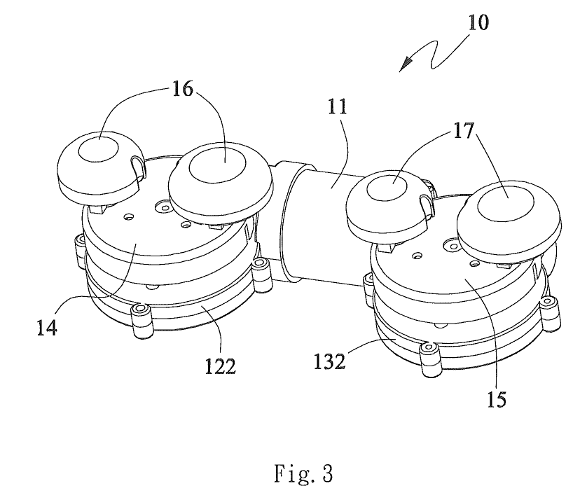

Please refer to FIGS. 1, 2 and 3. FIG. 1 is a perspective exploded view of a part of the present invention. FIG. 2 is a perspective exploded view of the present invention. FIG. 3 is a perspective assembled view of the present invention. The kneading massage device 10 of the present invention includes a driving motor 11, a first gear 12, a second gear 13, a first rotary seat 14 and a second rotary seat 15. The driving motor 11 has a first transmission shaft 111 and a second transmission shaft 112. The circumferences of the first and second transmission shafts 111, 112 are both formed with threads. The first gear 12 is engaged with the first transmission shaft 111 and provided with a first transmission shank 121. The first rotary seat 14 is coupled with the first transmission shank 121. A first massage unit 16 is disposed on the first rotary seat 14. The second gear 13 is engaged with the second transmission shaft 112 and provided with a second transmission shank 131. The second rotary seat 15 is coupled with the second transmission shank 131. A second massage unit 17 is disposed on the second rotary seat 15. When the driving motor 11 drives the first and second transmission shafts 111, 112 to rotate, the threads on the circumferences of the first and second transmission shafts 111, 112 will drive the first and second gears 12, 13 to rotate. At this time, the first and second transmission shanks 121, 131 will rotate and drive the first and second rotary seats 14, 15 to rotate. In this case, the first and second massage units 16, 17 disposed on the first and second rotary seats 14, 15 will rotate along with the first and second rotary seats 14, 15. Accordingly, a user can use the first and second massage units 16, 17 to knead and massage a human body.

The first and second gears 12, 13 are respectively enclosed in a first housing 122 and a second housing 132 for preventing the first and second gears 12, 13 from contacting any alien article and thus protecting the kneading massage device 10 from damage.

In real person massage, a massager's thumbs often circulate to knead the human body in reverse directions. In order to simulate the real kneading movement, the first and second massage units 16, 17 of the present invention are rotated in reverse directions to knead the human body. To achieve this, the driving motor 11 can control the first and second transmission shafts 111, 112 to rotate clockwise and counterclockwise respectively. In this case, the first and second massage units 16, 17 are driven to rotate in reverse directions. Alternatively, the first and second transmission shafts 111, 112 can be formed with threads having opposite spiral direction. Under such circumstance, when the first and second transmission shafts 111, 112 rotate in the same direction, the first and second gears 12, 13 are rotated in reverse directions to rotate the first and second massage units 16, 17 in reverse directions.

In order to also provide thermal therapy effect in the massage process, at least one heating unit 18 is added into the kneading massage device 10 of the present invention. The heating unit 18 is electrically connected to the first and second massage units 16, 17 to thermoelectrically heat the first and second massage units 16, 17. In this case, when massaging a human body, the kneading massage device 10 of the present invention can also provide a thermal therapy effect.

Moreover, in order to achieve a gradation effect in massage strength for a user, each of the first and second massage units 16, 17 includes two massage ball bodies with different volumes. When the massage ball bodies with different volumes rotate and touch a user's body, the user can feel the gradational massage strength.

In conclusion, the kneading massage device of the present invention can be used to massage a user's neck, waist, arms, thighs, legs, etc. as necessary to quickly release a user from fatigue. In addition, the kneading massage device of the present invention is able to relax the user's muscles from tension and soreness. Also, the kneading massage device of the present invention is able to speed blood circulation of the user to increase oxygen supply for cells and activate the cells. The kneading massage device of the present invention is lightweight and portable and can be easily and conveniently operated.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. A kneading massage device comprising:
a driving motor having a first transmission shaft and a second transmission shaft;
a first gear engaged with the first transmission shaft and provided with a first transmission shank;
a first rotary seat coupled with the first transmission shank, a first massage unit being disposed on the first rotary seat;
a second gear engaged with the second transmission shaft and provided with a second transmission shank; and
a second rotary seat coupled with the second transmission shank, a second massage unit being disposed on the second rotary seat, whereby when the driving motor drives the first and second transmission shafts to rotate, the first and second massage units are synchronously driven and rotated.

2. The kneading massage device as claimed in claim 1,
wherein the first and second gears are respectively enclosed in a first housing and a second housing.

3. The kneading massage device as claimed in claim 1, further comprising a heating unit electrically connected to the first and second massage units to thermoelectrically heat the first and second massage units.

4. The kneading massage device as claimed in claim 1, wherein each of the first and second massage units includes two massage ball bodies with different volumes.
